(19) United States
(12) Patent Application Publication
(10) Pub. No.: US 2026/0370685 A1
(43) Pub. Date: Nov. 19, 2026

(54) AUTHENTICATION DEVICE FOR A VEHICLE

(71) Applicant: Continental Automotive Technologies GmbH, Hannover (DE)

(72) Inventor: Helge Zinner, Regensburg (DE)

(73) Assignee: Continental Automotive Technologies GmbH, Hannover (DE)

(21) Appl. No.: 19/138,695

(22) PCT Filed: Dec. 1, 2023
(86) PCT No.: PCT/DE2023/200241

§ 371 Date: Jun. 13, 2025

(30) Foreign Application Priority Data
Dec. 13, 2022 (DE) 10 2022 213 582.2

(51) Int. Cl. H04L 9/40; H04L 67/12

(52) U.S. Cl. CPC H04L 63/18; H04L 63/1416; H04L 67/12

(57) ABSTRACT

An authentication device authenticates a network of network nodes for a vehicle. The authentication device determines an overall validation value of an addable quantity of authentication messages over the network nodes, compares the determined overall validation value with an overall validation value expected by the authentication device, and authenticates the network based on the comparison of the expected overall validation value with the determined overall validation value.

### CROSS-REFERENCE TO RELATED APPLICATIONS

The present application is a National Stage Application under 35 U.S.C. § 371 of International Patent Application No. PCT/DE2023/200241 filed on Dec. 1, 2023, and claims priority from German Patent Application No. 10 2022 213 582.2 filed on Dec. 13, 2022, the disclosures of which are herein incorporated by reference in their entireties.

### TECHNICAL FIELD

The invention relates to an authentication device for a vehicle, a network node, a method for authenticating a network of network nodes for a vehicle, a program element and a storage medium.

### BACKGROUND

In partially automated and highly automated driving, there are increasing demands on the vehicle that require hard real-time support from the transmission network and the protocols. It is necessary to be able quickly to trust the datasets, and the integrity of the data must be ensured. An on-board electrical system will also be much more flexible in the future than it is today. Nodes are shut down during operation when they are not needed. This in turn means that the on-board electrical system will change dynamically to a very large degree at runtime. Hardware plug'n'play of sensors is becoming an increasingly important topic. In vehicles, therefore, it is increasingly difficult to detect such events as a change in communication, an attack via the diagnostic access, a manipulated control unit and replaced control units.

### BRIEF SUMMARY

An object of the invention is to provide improved authentication of a network for a vehicle.

The object is achieved by the subjects of the independent patent claims. The dependent claims, the following description, and the figures relate to advantageous embodiments.

The embodiments described similarly relate to the authentication device for a vehicle, the network node, the method for authenticating a network of network nodes for a vehicle, the program element and the storage medium. Synergy effects can arise from different combinations of the embodiments, even though they may not be described in detail.

Furthermore, it should be noted that although all the embodiments of the present invention that relate to a method can be implemented in the described order of steps, this need not be the only and essential order of the steps of the method. Unless expressly stated otherwise below, the methods presented here can be implemented using a different order of the disclosed steps without departing from the associated method embodiment.

According to a first aspect, an authentication device is provided, which is designed to authenticate a network of network nodes for a vehicle. The authentication device is designed to determine an overall validation value of an addable quantity of authentication messages over the network nodes, to compare the determined overall validation value with an overall validation value expected by the authentication device, and to authenticate the network on the basis of the comparison of the expected overall validation value with the determined overall validation value.

For example, the authentication messages are special messages that are generated and sent for authentication only. The authentication device can be one of the network nodes, which, for example, additionally or as a dedicated device, has special services or program elements necessary for authentication.

Such authentication can be performed, for example, during a setup or when starting or booting up the network, or when any manipulation of the network occurs. A manipulation is, for example, the replacement of a network node or a software update. A software update in this case can relate to a configuration or an update of a program or program part, such as a dynamic library file.

According to one embodiment, the validation value is a message length or a transit time. For example, a message length can be a number of transmission units such as bits or symbols. A transit time can be derived from the number of transmission units and the transmission speed and can be determined, for example, by measuring or determining the received bits.

In an example, the validation value is exclusively a message length or exclusively a transit time.

For example, the authentication device and the network nodes are connected to one another via a network bus, herein, i.e. in this disclosure, also abbreviated to bus. For example, the authentication messages may have a header with an ID to identify the message type. The message body, i.e. the content of the message or the so-called “payload”, is irrelevant and does not need to be decoded. The only important part is the length of the message, which is defined, for example, by the number of bits in the payload or the total number of bits in the message. The transit time is then obtained from the number of bits and the transmission speed.

According to one embodiment, the authentication device is designed to transmit a beacon, wherein the beacon is the request to a first network node to generate and send an authentication message, and wherein the authentication device is designed to receive an authentication message from a second network node that is different from the first network node, and is designed to determine an overall validation value, wherein the overall validation value corresponds to the added validation values of the authentication messages of the first network node and the second network node.

This means that transmitting the beacon causes the first network node to send an authentication message. The authentication device waits until it receives an authentication message from the second network node and determines an added validation value from the authentication messages of the first network node and the second network node. It follows implicitly that, in order to obtain an added validation value, the second network node sends the message to the second network node to enable the addition, and the authentication device can determine an added quantity, such as an overall transit time or overall length. The authentication device can be configured to perform an addition itself or to measure a time until it has received the message from the second node. This is caused by the serial sending of the authentication messages via the first and second network nodes. It should be noted that between the first and second network nodes there may be other network nodes, the validation values of which can then be added to those of the first and second network nodes. The determined transit time or “overall transit time” may contain offsets which arise at the network node or by the transmission of the beacon, which may be partly physical in nature and partly due to data processing or specifications, e.g. by a standard.

Once the authentication device has received an authentication message, it can transmit a beacon again. Such an authentication process represents a cycle, and is referred to as such in this disclosure. The duration or time period of this cycle is equal in size to the overall validation value and is also referred to herein as the cycle length.

According to one embodiment, the authentication device is a network node, a bus master and/or a gateway. However, it can also be a control unit, for example, that has the appropriate prerequisites.

According to a second aspect, a network node of a network for a vehicle is provided, wherein the network node is designed, for authentication of the network, to receive a beacon or an authentication message, to generate an authentication message, which is defined with regard to the authentication by a validation value of an addable quantity of the authentication messages, and to send the generated authentication message.

As mentioned earlier, the validation value can be a message length or a transit time, and in particular only one of these variables.

Here, under primary consideration is a network that has a network bus on which only one node is allowed to send at a time. For example, the network node is also configured to send the authentication message over the bus when its turn comes around. This is the case, for example, after a predecessor node has sent its message with an address or ID known to it. For example, the address or ID of the predecessor node is preconfigured or can be obtained from the authentication device.

In this way, a chain can be formed, which begins with the reception of a beacon and passes through one or more other network nodes in turn to end at the authentication device again, which determines the cumulative transit time or the cumulative length of the authentication messages. In the latter case, for example, the authentication message, or its payload, of the preceding network node could be appended to the authentication message generated by the current network node, or else the authentication device determines the length of the authentication messages each time a node involved in the authentication sends one, and adds the lengths one at a time.

According to one embodiment, the network node is a control unit (ECU, electronic control unit), a sensor, a display device, an actuator or another network-enabled device. In all cases, the network node must have hardware logic and/or software logic that can generate and send the authentication messages.

According to a third aspect, a network is provided, which comprises an authentication device described herein and at least one network node described herein. The network can additionally have a network bus and is not limited to one authentication device.

In a variant, there may be one or more further authentication devices present on the network. The beacon is a network-wide signal or network-wide message that can be received by all network nodes. If another authentication device is present on the network that also knows an intrinsically valid overall validation quantity, it can also perform authentication. In this case, the boot authentication device is different from the device that performs the authentication. In another variant, the additional authentication device can be part of the chain, i.e., so to speak, an intermediate authentication station, which sends an authentication message itself again. This allows multiple authentication devices to exist in the chain.

The authentication device, e.g. a bus master, can thus be configured to receive the last authentication message of the chain and to record the validation value of an addable quantity of the authentication messages for authentication.

According to one embodiment, the validation value of the authentication messages is individual to each network node. The network node can be configured with a validation value statically or dynamically, wherein the validation values typically vary from network node to network node.

According to one embodiment, the network has further network nodes, and the authentication device is designed to determine, according to a dynamically generated or stored security pattern, which network node is part of the chain.

According to one embodiment, the security pattern further contains one or more of the following values: individual validation value for each network node, ID of the preceding network node.

This means that the validation value for a network node and a receiver node can be preconfigured. The validation value, e.g. the individual length of an authentication message of a network node, can be configured, for example, before delivery, so that the individual value is known only to the affected network nodes. Furthermore, each network node only knows about the predecessor node, which is preconfigured or dynamically communicated to it.

The authentication device can thus be configured to send the validation value to the network nodes. This increases the flexibility. Security is provided by the fact that, unless a malicious device knows the overall transit time or the overall length, it is not possible for it to configure a single, for example, malicious network node or all network nodes with validation values that result in a valid overall validation value. All that is needed is to ensure that the overall transit time or the overall length of the authentication messages remains secret and cannot be manipulated, and that the validation value of a network node cannot be read, for example, if it is extracted from the network and analyzed by an attacker. Since the network is secure after before a network node is replaced by a malicious network node, for example, it can also be assumed that there is no malicious software in the network that can read the validation values during the transit time.

In principle, the network could consist of the authentication device and one or more network nodes. However, several such networks or subnetworks could also exist side by side. This could allow a malicious device to be directly identified or at least localized.

According to one embodiment, the network is based on a physical layer according to an Ethernet standard.

Ethernet standardizations available for automotive applications include, for example, the 10 Mbps IEEEP802.3cg standard, or standardizations with 100 Mbps, 1000 Mbps, or even 2.5, 5, or 10 Gbps. A variant of the IEEEP802.3ch standard is the CSMA/CD-based multidrop mode, which does not require switches (switch ICs) but is designed as a bus. The IEEE P802.3cg standard uses, inter alia, a mechanism (PLCA, Physical Layer Collision Avoidance) to avoid collisions during bus access and to obtain fair access. Only one PHY (transceiver) is ever given access to the bus at exactly one time. This makes it possible to avoid collisions. Access is based on what is called a round-robin method. Each electronic control unit (ECU) or each node on the bus has the possibility to send within a defined cycle (or sequence). A so-called head node in this case determines the cycle and transmits “beacons” on the bus on a recurring basis. This causes the nodes to start a timer, depending on the ID of the predecessor node known to them, which determines the sequences, when they are allowed to send, and in turn to send after the timer expires and the recognition that it is their turn.

According to one aspect a method for authenticating a network of network nodes for a vehicle is provided. The method comprises the following steps:
determining an overall validation value of an addable quantity of authentication messages over the network nodes;
comparing the overall validation value with an expected overall validation value;
authenticating the network on the basis of the comparison of the expected transit time with the determined transit time.

The method thus provides a mechanism in which all control units together form a kind of blockchain via which they are authenticated. If only one node makes a minimal change to the communication, the one authentication device and the bus can be classified as insecure, for example.

In accordance with a further aspect, a program element is provided, which, when it is executed on a processor of the authentication device, instructs the authentication device to carry out the steps of the method described above.

The computer program element can be part of a computer program, but it can also be a whole program by itself. For example, the computer program element can be used to update a computer program already available, in order to arrive at the present invention.

According to a further aspect, a storage medium is provided, on which the program element is stored.

The computer-readable medium can be regarded as a storage medium, such as, for example, a USB stick, a CD, a DVD, a data storage device, a hard disk or any other medium on which a program element as described above is kept stored.

The invention can be used to detect, for example, a change in the network, such as an attack via the OBD access, a replacement or manipulation of a control unit or an access to security-critical control units via OBD or infotainment. Attacks such as hacker attacks on vehicle networks and theft can also be detected and prevented. Sensors and sensor data can also be authenticated.

In carrying out the claimed invention, a person skilled in the art can understand and implement other variations of the disclosed embodiments through studying the drawings, the disclosure and the accompanying claims. The word “comprising” in the claims does not exclude other elements or steps, and the indefinite article “a” or “an” does not exclude more than one. A single processor or another unit can fulfil the functions of a plurality of objects or steps presented in the claims. The mere fact that certain measures are specified in mutually dependent claims does not mean that a combination of these measures cannot be used advantageously. A computer program can be stored/distributed on a suitable medium such as an optical storage medium or a semiconductor medium, which is supplied together with or as part of other hardware, but can also be distributed in other forms, for example via the Internet or other wired or wireless telecommunication systems. Reference signs in the claims should not be construed as limiting the scope of the claims.

### BRIEF DESCRIPTION OF THE DRAWINGS

Exemplary embodiments of the invention are explained in more detail below with reference to the schematic drawings.

FIG. 1A shows a diagram of a first example scenario.

FIG. 1B shows a diagram of a second example scenario.

FIG. 2 shows a block diagram of a network according to one exemplary embodiment.

FIG. 3 shows a flowchart of a method for authenticating a network.

FIG. 4A shows a diagram of a valid bus cycle.

FIG. 4B shows a diagram of an invalid bus cycle.

FIG. 5 shows a flowchart of the method with additional steps.

FIG. 6 shows a flowchart of the method with focus on security patterns.

FIG. 7A shows a first security pattern example.

FIG. 7B shows a second security pattern example.

FIG. 8 shows a vehicle having a network according to one exemplary embodiment.

Corresponding parts are provided with the same reference symbols in all of the figures.

### DETAILED DESCRIPTION

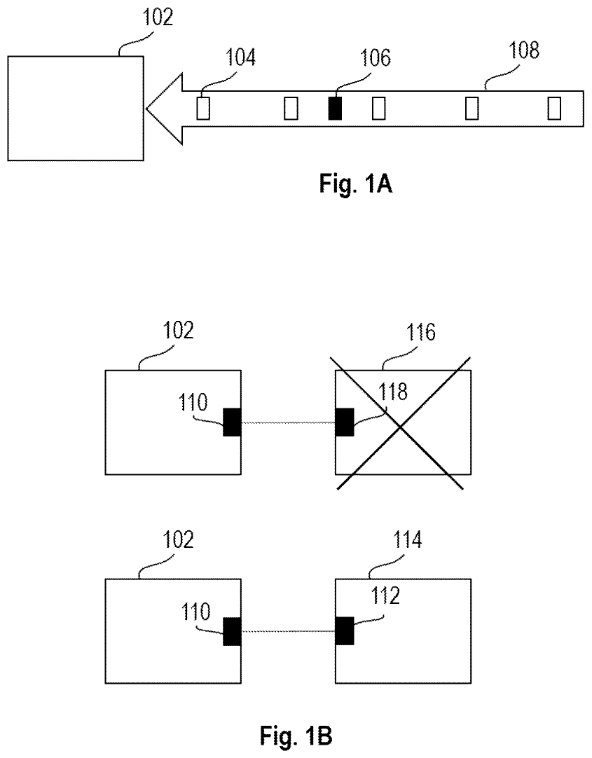

FIG. 1A shows a diagram of an example scenario in which an intervention takes place in an existing communication link 108 on a network bus. In the data stream to an ECU 102, an additional data packet 106 of a malicious software is inserted between the regular data packets 104. The sender of the data stream including the additional data packet 106 is the same. Such a data packet in an authentication message would change its length and thus be detected.

FIG. 1B shows a diagram of a second scenario with a manipulation of control units in which a control unit 114 is replaced. In the normal case, the ECU A 102 communicates with the ECU B 114 via the transceivers 110 and 112. In an attack scenario, the ECU B 114 could be replaced by an ECU B′ 116 with transceiver 118, for example to bypass an immobilizer system or to manipulate the engine controller. From the application point of view, it cannot be detected that the control unit ECU B′ 116 has been replaced. The control unit ECU B′ 116 can, for example, assume the original name of the original control unit ECU B 114, such as an ID, an IP address or a bus system address, and is thus invisible to the software. This presents a potential hazard and can also affect sensors and actuators.

In another example scenario, a jump from, for example, an infotainment domain of an ECU server or domain controller into a driver assistance system (ADAS, Advanced Driver Assistance System) domain is to be prevented.

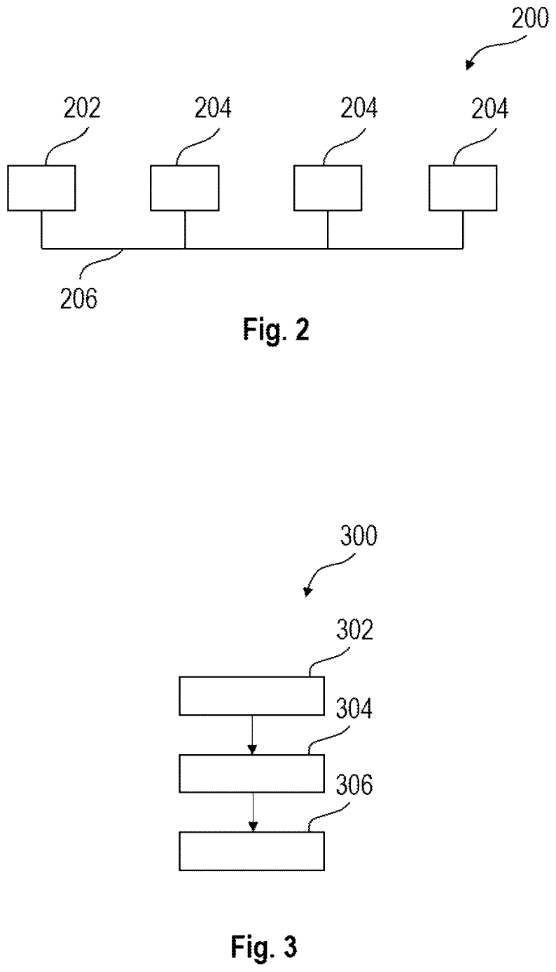

FIG. 2 shows a block diagram of a network comprising an authentication device 202 and a plurality of network nodes 204 and a network bus 206.

FIG. 3 shows a block diagram of a method 300 for authenticating a network of network nodes for a vehicle, comprising the following steps: determining 302 an overall validation value of an addable quantity of authentication messages over the network nodes, comparing 304 the determined overall validation value with an expected overall validation value, and authenticating 306 the network on the basis of the comparison of the expected overall validation value with the determined overall validation value.

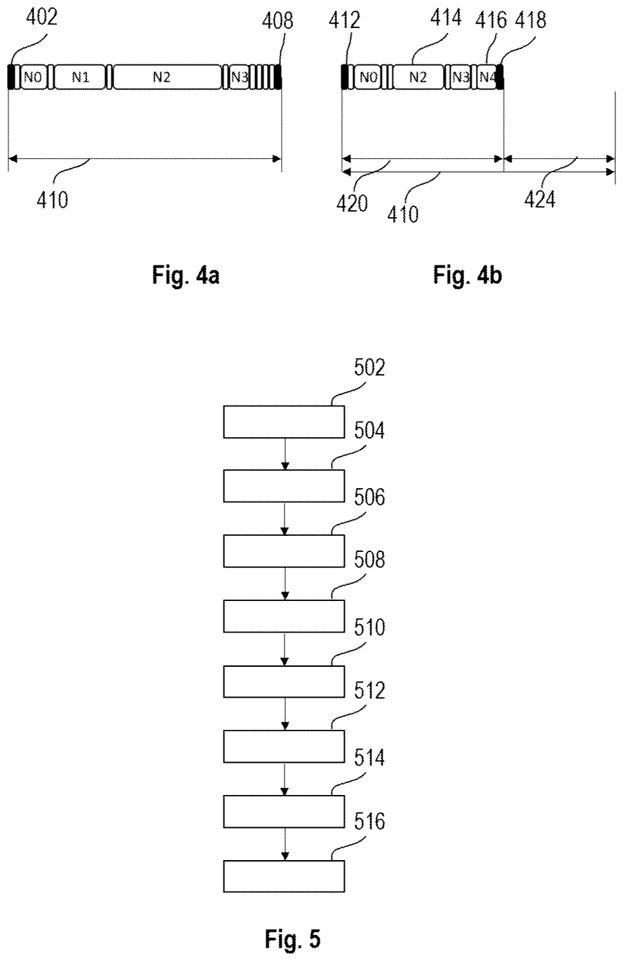

FIGS. 4A and 4B show the effects of attacks and unauthenticated devices on the bus in a case in which the overall transit time 410 is known to the network nodes N0, N1, N2, N3. If a node 414, 416 is newly or additionally added, the overall transit time 410, 420 changes and shifts the transmission of the next beacon 408, 418 by a difference 424, so that a deviation from the expected overall transit time 410 can be detected. Any interested node can detect this shift.

FIG. 4A illustrates the secure scenario. Each network node, such as a control unit, a sensor or an actuator, follows the pattern and sends the exact message in the correct size (e.g. 200 bytes). The sum of all data packets or message lengths in the cycle (both sent and not sent) then defines the cycle length 410, i.e. the overall validation value, and thus also the time of transmission of the next beacon 408, 410, which is received by all subscribers N0, N1, N2, N3. No synchronization is necessary for this, as each network node transmits immediately when the bus is free (in compliance with the specified sequence). This means that the method works without the need for precise coordination over the transmission cycle. FIG. 4B illustrates a case in which an attack or an error exists. One or more subscribers, i.e. network nodes 414, 416, are affected and behave differently than defined by the security pattern. This does not initially affect the bus communication. However, the actual cycle length is affected and differs significantly from the previously defined value. This can then be identified as a problem. No network node needs to know the overarching pattern or have knowledge of the data of the other network nodes, which is a particular advantage of the method. For example, the network nodes only know about the beginning of the next cycle. The method is therefore also particularly suitable for a highly distributed system. At the time of transmitting the new beacon 408, which is transmitted by the authentication device or master, each network node will then know whether or not the bus can be considered secure.

The method 300 presented in FIG. 3 can be part of a network procedure with further steps, which includes the following steps as shown in FIG. 5:

In step 502 the network bus is initialized.

In step 504, the number of bus nodes that are capable of sending is determined, i.e. the network nodes described here.

In step 506 a security pattern is defined. For example, the security pattern contains the individual validation values, such as the transit time or length of the authentication message. These can be set, for example, by means of a random number generator. The security pattern can additionally define the order in which the network nodes send their authentication message. The network nodes thus form a chain with, for example, the authentication device as the beginning and end link, wherein the authentication device itself does not generate or send an authentication message. Alternatively, there are other authentication devices in the chain that do not necessarily generate and distribute a security pattern, but obtain it from the bus master.

In step 508, the overall validation value is calculated using the pattern. Alternatively, for example, an overall validation value can also be defined first or already be configured and the security pattern in step 506 is defined under the condition of this specified overall validation value. The overall validation value can optionally be sent to all network nodes. Alternatively, the overall validation value can be sent to a subset of network nodes, which can then also perform an authentication.

In step 510, for example, the security pattern is sent to the network nodes in an individual form. This means that, for example, the length of the authentication message to be generated and the ID of the predecessor node are sent to each network node. Alternatively, steps 504 through 510, or some of these steps, can be replaced with a pre-configuration. The sequence of steps 510 and 508 can also be reversed.

In step 512 a beacon is transmitted that starts the sending of the authentication messages.

In step 514, the authentication messages are generated and sent by the network nodes in the order defined by the respective validation value. This means that each node on the bus sends a predefined data packet, for example after the start-up or initialization or after the vehicle starts. Only the size of the packet is relevant and not the contents. This allows the bus cycle to be implicitly mapped. Only after one node has transmitted can the next node transmit, and so on. If it is the turn of all the nodes, the master can transmit a new beacon to start a new cycle, so the time at which this new beacon is transmitted depends solely on the sum of the node delays. Thus, each subscriber has a direct influence on this point in time. The next beacon time can therefore be predicted exactly.

In step 516, the overall validation value is validated, i.e., the authentication is performed and the overall validation value is checked according to the method 300.

For example, steps 504 through 512 and 516 can be performed by the authentication device.

FIG. 5 thus also illustrates the process of bus identification and the pattern definition and transmission. There may be different times for checking the authentication. This can involve a so-called “terminal 30”, i.e. if the power supply is connected, or a service, a plug'n'play of a new control unit, or at any other time that is either permanently configured or is communicated dynamically to the subscribers on the bus.

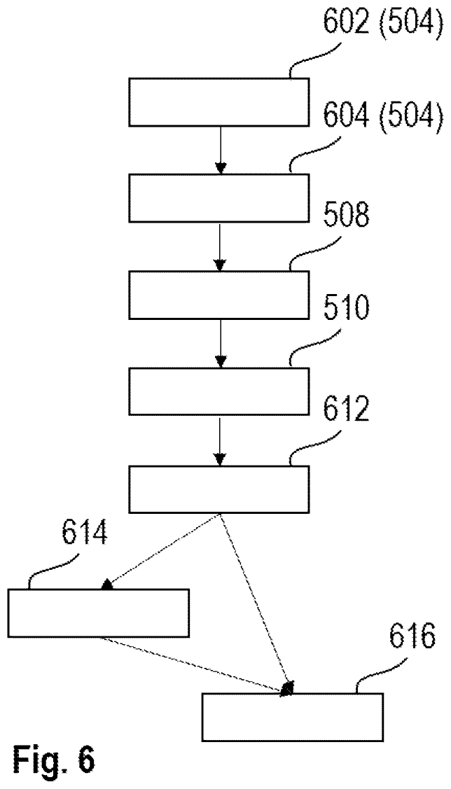

In order to define the cycle length, it is necessary to know the number of subscribers—i.e. which control units are to be included in the security procedure, or which control units are to be tested. For example, everyone could always be included, or even just a subset of the connected subscribers. The subset can involve control units which are either particularly security-critical, devices with a monitoring function or even only devices that can technically participate in the method. This is illustrated in FIG. 6. Furthermore, it should also be taken into account which control units are used for monitoring, i.e. as authentication devices.

FIG. 6 shows a flowchart of the method with a focus on the creation and transmission of the security pattern. The reference signs are related to FIG. 5. Step 504 is divided into two substeps 602 and 604. Accordingly, it is determined in 602 which control units or subscribers are to be checked by the procedure. These include, for example, newly connected control units, control units that have been in sleep mode, control units with online connection, multiple interfaces, etc. In step 604, the control units that are to be informed about the security result are determined, such as only the bus master, all control units or diagnostic devices, etc. In step 508, the method either determines a security pattern dynamically or uses a previously saved and pre-configured pattern. The pattern defines which subscriber or network node (ECU, sensor, actuator, etc.) sends an authentication message. The pattern also defines the message lengths to be sent. This does not require time synchronization, because the control units send in sequence or when the previous one has sent its authentication message. In step 510 the cycle length or the overall validation value is calculated. In step 612 it is decided whether further control units will be notified. If only the bus master is to monitor the bus as an authentication device, such as the gateway, then in step 616 only the pattern is transmitted. In this case, the cycle length does not need to be transmitted. Otherwise, i.e. if additional control units are to be consulted for checking, the cycle length can first be transmitted in step 614 and then the procedure moves to step 616 to transmit the pattern. This itself is not confidential information, because an attacker cannot do anything with the actual number or value. Only when the combination of all control units is known can the overall validation value be reached.

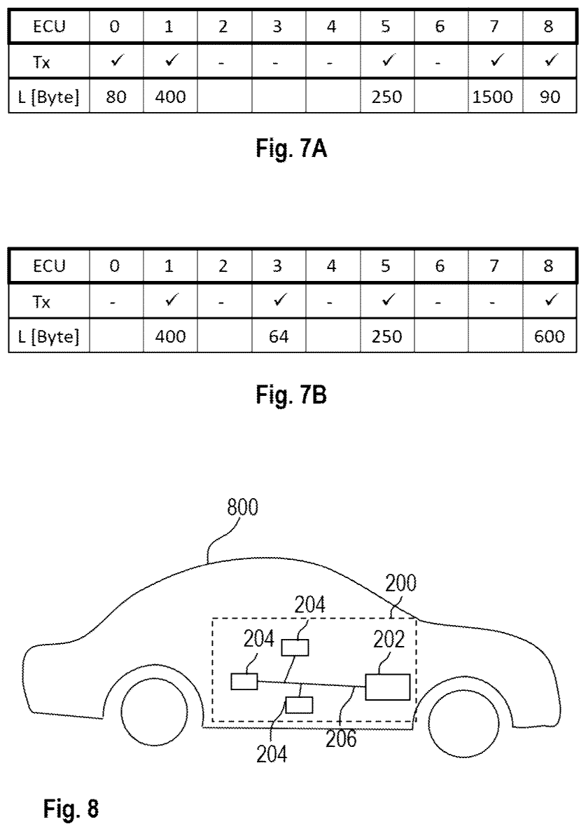

FIGS. 7A and 7B show two examples of a security pattern 702. In the pattern 702 shown in FIG. 7A, the nodes 0,1,5,7 and 8 send (Tx) an authentication message with the specified length L in bytes, while all other nodes do not send an authentication message. The nodes that do not send an authentication message are also part of the pattern 702, because the non-sending also affects the cycle length. The advantage of this is that the pattern 702 does not have to be completely distributed or known, rather only the respective node must know its own values. In FIG. 7B, nodes 1,3,5 and 8 send an authentication message. The lengths L differ partially from those of the pattern 702 in FIG. 7A.

The security level works by a combination of all subscribers, similar to a blockchain-based system. The applied pattern then uniquely determines the cycle length. Different patterns are possible here. In a first example, the pattern is a static pattern that is provided encrypted and programmed. In a second example, the pattern is a dynamically created pattern. In a third example, the pattern is based on predefined parameters such as the current time of day. In a fourth example, the pattern is based on the MAC addresses of the subscribers.

In one exemplary embodiment, the pattern does not directly specify the length of the authentication message, but it can contain one or more parameters from which the network node can derive the length. For example, the authentication device which is the master sends a parameter value to the network node, e.g. a control unit, which the control unit adds to the last two digits of its MAC address and then uses as the length for the next data packet, here equivalent to the authentication message. The pattern can also be permanently coded in a secure memory area and then queried on request, or it can be used to determine the frame length.

FIG. 8 schematically shows a vehicle 800 with a network 200 described herein, comprising an authentication device 202, a plurality of network nodes 204, and a network bus 206.

The method makes it possible to block attacks at the level of the hardware and thus not to even allow them to reach the ECU software or even possibly be forwarded. This relieves the load on resources as well as possible firewalls. The use of the method means that the attacker can no longer gain entry to the system. In addition, attacks can not only be averted, but the very attempt can even be diagnosed. The method also provides another method to allow only authorized access to the vehicle on-board network. The current hardware does not have to be changed, but the existing hardware can be reused. The computing capacities required are low, so that a security procedure can be implemented and subsequently written to the flash memory without affecting the system resources (memory, computing power, real-time capability). The method also has the special advantage that there is no need to actively intervene in the communication. The security procedure can be executed and verified silently. In addition, not all control units need to participate in the method. The method can also be evaluated in real time and does not require any further computation or analysis in a cloud.

1. An authentication device, designed to authenticate a network of network nodes for a vehicle;
wherein the authentication device is designed to determine an overall validation value of an addable quantity of authentication messages over the network nodes, to compare the determined overall validation value with an overall validation value expected by the authentication device, and to authenticate the network on the basis of the comparison of the expected overall validation value with the determined overall validation value.

2. The authentication device as claimed in claim 1, wherein the validation value is a message length or a transit time.

3. The authentication device as claimed in claim 1, wherein the authentication device is designed
to transmit a beacon, wherein the beacon is the request to a first network node to generate and send an authentication message;
to receive an authentication message from a second network node that is different from the first network node; and
to determine an overall validation value, wherein the overall validation value corresponds to the added validation values of the authentication messages of the first network node and the second network node.

4. The authentication device as claimed in claim 1, wherein the authentication device is a bus master and/or a gateway.

5. A network node of a network for a vehicle, wherein the network node is designed, for authentication of the network,
to receive a beacon or an authentication message;
to then generate a dedicated authentication message, which is defined with regard to the authentication by a validation value of an addable quantity of the authentication messages; and
to send the generated authentication message.

6. The network node as claimed in claim 5, wherein the network node is a control unit, a sensor, or an actuator.

7. A network, comprising an authentication device as claimed in claim 1; and
at least one network node of a network for a vehicle, wherein the network node is designed, for authentication of the network,
to receive a beacon or an authentication message;
to then generate a dedicated authentication message, which is defined with regard to the authentication by a validation value of an addable quantity of the authentication messages; and
to send the generated authentication message.

8. The network as claimed in claim 7, wherein the validation value of the authentication messages is individual for each network node.

9. The network as claimed in claim 7, wherein the network comprises further network nodes, and wherein the authentication device is designed to determine, according to a dynamically generated or a stored security pattern, which network node is part of the chain.

10. The network as claimed in claim 8, wherein the security pattern further contains one or more of the following values: individual validation value for each network node, ID of the preceding network node.

11. The network as claimed in claim 7, wherein the network is based on a physical layer according to an Ethernet standard.

12. A method for authenticating a network of network nodes for a vehicle, comprising:
determining an overall validation value of an addable quantity of authentication messages over the network nodes;
comparing the determined overall validation value with an expected overall validation value; and
authenticating the network on the basis of the comparison of the expected overall validation value with the determined overall validation value.

13. An authentication device, designed to authenticate a network of network nodes for a vehicle, wherein the authentication device is designed to determine an overall validation value of an addable quantity of authentication messages over the network nodes, to compare the determined overall validation value with an overall validation value expected by the authentication device, and to authenticate the network on the basis of the comparison of the expected overall validation value with the determined overall validation value, the authentication device having a non-transitory computer-readable medium having stored thereon computer-executable instructions, which, when executed by a processor of the authentication device, cause performance of operations comprising:
determining an overall validation value of an addable quantity of authentication messages over the network nodes;
comparing the determined overall validation value with an expected overall validation value; and
authenticating the network on the basis of the comparison of the expected overall validation value with the determined overall validation value.

14. A non-transitory computer-readable medium having stored thereon computer-executable instructions, which, when executed by a processor of an authentication device, cause performance of operations comprising:
determining an overall validation value of an addable quantity of authentication messages over the network nodes;
comparing the determined overall validation value with an expected overall validation value; and
authenticating the network on the basis of the comparison of the expected overall validation value with the determined overall validation value.

15. A vehicle having an authentication device designed to authenticate a network of network nodes for a vehicle:
wherein the authentication device is designed to determine an overall validation value of an addable quantity of authentication messages over the network nodes, to compare the determined overall validation value with an overall validation value expected by the authentication device, and to authenticate the network on the basis of the comparison of the expected overall validation value with the determined overall validation value.
